(19) United States
(12) Patent Application Publication
(10) Pub. No.: US 2025/0387991 A1
(43) Pub. Date: Dec. 25, 2025

(54) PACK FOR MOUNTING ELECTRONIC DEVICE TO TIRE

(71) Applicants: KORDSA TEKNIK TEKSTIL ANONIM SIRKETI, Kocaeli (TR); SES RFID SOLUTIONS GMBH, Duesseldorf (DE)

(72) Inventors: Ezgi TAMAN ONEN, Kocaeli (TR); Ahmet Burak ILGUN, Kocaeli (TR); Sule ASKIN, Kocaeli (TR); Mehmet Saadettin FIDAN, Kocaeli (TR); Mehmet Ilker YILMAZ, Kocaeli (TR); Yu Cheng LEE, Taichung (TW); Ping Jung CHAO, Taichung (TW); Martin SCATTERGOOD, Duesseldorf (DE)

(73) Assignees: KORDSA TEKNIK TEKSTIL ANONIM SIRKETI, Kocaeli (TR); SES RFID SOLUTIONS GMBH, Duesseldorf (DE)

(21) Appl. No.: 18/880,010

(22) PCT Filed: Jun. 12, 2023
(86) PCT No.: PCT/TR2023/050553

§ 371 Date: Dec. 30, 2024

(30) Foreign Application Priority Data
Jul. 1, 2022 (EP) 22182643.1
Jul. 1, 2022 (TR) 2022/010949

(51) Int. Cl. B29D 30/00; B60C 19/00

(52) U.S. Cl. CPC B29D 30/0061; B60C 19/00; B29D 2030/0077; B60C 2019/004

(57) ABSTRACT

An electrical device pack includes an adhesive layer deposited onto a transfer layer, an electrical device, such as an RFID transponder, deposited onto said adhesive layer and a tear-off cover in order to protect said electrical device. The electrical device pack provides a ready to use electrical device that can be directly applied onto the uncured rubber of a tire product without requiring further processing. A method for attaching an electrical device to a tire using said electrical device pack allows exact positioning of the tag on the desired location and in a desired alignment on the tire without overhandling the tag and causing damage.

### CROSS REFERENCE TO THE RELATED APPLICATIONS

This application is the national phase entry of International Application No. PCT/TR2023/050553, filed on Jun. 12, 2023, which is based upon and claims priority to European Patent Application No. 22182643.1 and Turkish Patent Application No. 2022/010949, both filed on Jul. 1, 2022, the entire contents of which are incorporated herein by reference.

### TECHNICAL FIELD

The present invention relates to a pack for mounting an electrical device to a tire and a method of mounting an electrical device to a tire. More specifically, the present invention relates to a pack for mounting an RFID tag to a tire and a method of mounting an RFID tag to a tire.

### BACKGROUND

It is known that incorporating electrical devices into tire structures has many advantages, such as tracking the tire during manufacture, transport and storing operations, as well as measuring physical parameters, such as temperature and pressure. Different types of electrical devices are used in the art for these purposes, with radio frequency communication between the tire and an external monitoring or interrogating device being the most common. Such communication systems often include a radio-frequency identification (RFID) tag, and a reader that communicates with the RFID tag. The RFID tag includes an antenna and an RFID chip. Thus, information from the reader is received through the antenna and stored in an RFID chip, and the information stored in the RFID chip is transmitted to the reader through the antenna. RFID devices may be read-only, write-only, or read-and-write devices.

RFID tags and other electrical devices may be mounted to a tire in a tire mountable apparatus. One of the problems associated with RFID tags is how to position and configure the antenna such that the data in the device are accurately transmitted to the information gathering device outside of the tire. The issues related to the use of RFID tags in tires are: (i) positioning the antenna as close to the outside of the tire as possible so that transmission efficiency is improved, (ii) positioning the antenna away from the metal reinforcing cords that interfere with the signal propagation, (iii) providing a device that can withstand the cyclic stresses in the operating tire, (iv) mounting the device onto the tire without overhandling and damaging it, and (v) ensuring the adhesion between the antenna, typically a metallic element, to the rubber material to secure it in place.

Examples of attaching electrical devices onto tires found in the state of the art are given below.

U.S. Pat. No. 10,513,153 discloses a tire including a circumferential tread and a radio-frequency identification (RFID) chip disposed below the circumferential tread. RFID chip is secured within the tire by vulcanization, adhesives, patches, or barbs.

U.S. Pat. No. 8,833,409 discloses a pneumatic tire having a tag carried by the reinforcing belt. The tag may be disposed in the crown portion, reinforcing cords, the splice of the reinforcing belt, or in a depression formed in the outer surface of the tire sidewall. The tag may be encapsulated with an encapsulation material, such as an epoxy, in order to secure the tag to the tire sidewall.

EP 1 516 502 discloses a radio frequency antenna for use with a radio device embedded in a tire, including an antenna body and an insulating coating surrounding the antenna body, wherein the insulating coating has a dielectric constant less than a dielectric constant of the rubber material. The coating materials used include electrical shrink tubing, thermoplastic polycarbonate, butadiene rubber, low carbon rubber, isocyanate-based adhesives, polyethylene, insulating varnish, epoxy, TPE cellulose acetate, parylene, and insulating polyester varnish.

WO 2011/002440 discloses a tire mountable apparatus including a first layer, a second layer, a middle layer disposed between the first layer and the second layer, and an electrical device embedded in the middle layer. The middle layer of the tire mountable apparatus completely surrounds the electrical device and is formed from a potting compound, which is chosen from epoxies, silicones, and urethanes.

US 2021/053306 discloses a chemically treated, RFID equipped mesh tire label configured to be integrally incorporated within a vulcanized tire. The label includes a mesh face layer configured to be adhered to an outer surface of an unvulcanized tire, a mesh backing layer attached to the mesh face layer, and an RFID device affixed between the mesh layers. The mesh layers include woven or non-woven materials being formed of a polyamide, polyester, polyethylene, polypropylene, or cotton.

WO 2016/053933 discloses RFID labels incorporated in tires. The RFID labels include a face layer, one or more primer layers, an adhesive layer, an RFID component, and a liner. The adhesive layer is used to affix the RFID label onto the tire and includes unsaturated rubber, acrylic adhesives and/or rubber-acrylic based hybrids.

However, there is a need in the art for an easy-to-use system for mounting an electrical device to a tire.

### SUMMARY

The present invention discloses an electrical device tag pack including an adhesive layer deposited onto a transfer layer, an electrical device deposited onto said adhesive layer and a tear-off cover in order to protect said tag. The electrical device tag pack of the invention provides a ready to use electrical device that can be directly applied onto the uncured rubber of a tire product without requiring further processing. The present invention also discloses a method for attaching an electrical device to a tire using said electrical device pack, which allows exact positioning of the electrical device on the desired location and in a desired alignment on the tire without overhandling the electrical device, such as an RFID tag, and causing damage.

### BRIEF DESCRIPTION OF THE DRAWINGS

Accompanying drawings are given solely for the purpose of exemplifying an electrical device pack, whose advantages over prior art were outlined above and will be explained in brief hereinafter.

The drawings are not meant to delimit the scope of protection as identified in the Claims, nor should they be referred to alone in an effort to interpret the scope identified in said Claims without recourse to the technical disclosure in the description of the present invention.

FIGS. 1A and 1B demonstrate a schematic of a top view (A) and sectional view (B) of an electrical device pack.

FIG. 2 demonstrates a schematic of a method for mounting an electrical device onto uncured rubber.

### DETAILED DESCRIPTION OF THE EMBODIMENTS

The present invention proposes an electrical device pack (5) for attaching an electrical device (1) to a tire.

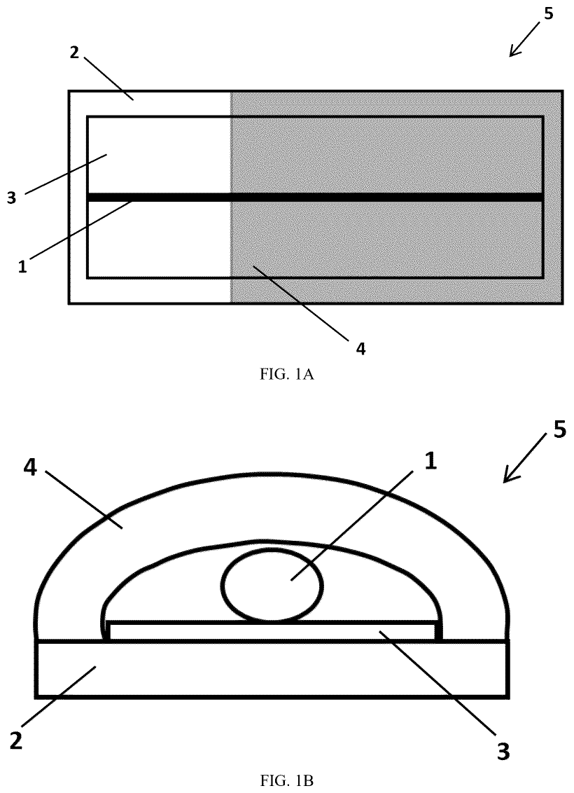

FIGS. 1A and 1B illustrate an electrical device tag pack (5) according to the present invention. Said electrical device pack (5) includes an adhesive layer (3) deposited onto a transfer layer (2), an electrical device (1) deposited onto said adhesive layer (3) and a tear-off cover (4) in order to protect said electrical device (1).

Said electrical device (1) can be an identification or tracking device, such as one that may be used in manufacturing, distribution, and sales activities, or a monitoring device for measuring temperature, pressure, or other physical parameters in an operating tire. In a preferred embodiment of the invention, said electrical device (1) is an RFID transponder including an RFID chip and an antenna in operable communication for wirelessly communicating with external equipment, such an RFID reader. A coil-shaped spring antenna, plate-shaped antenna, and various types of rod-shaped antennas can be used as the antenna. In a storage part inside the RFID chip, identification information such as a manufacturing number and part number is stored. However, the skilled person can appreciate that tire tag pack (5) may be used to secure and protect any electrical device or component without deviating from the scope or spirit of the present invention. Said tag (1) is an electrical device that may be used to wirelessly transmit data to a remote receiver and/or to receive data from a remote transmitter by way of an antenna.

Said electrical device (1) includes a tacky material that is pretreated with a tackifying solution in order to improve its adhesion to the rubber component of the tire. In a preferred embodiment of the invention, said tag is treated by dipping into a resorcinol formaldehyde latex (RFL) solution, as commonly used in the art. In alternative embodiments, resorcinol formaldehyde-free (RF-free) compositions, such as compositions containing acrylic resins and/or natural latex, can be used. In alternative embodiments, a rosin ester and/or rosin ester tackifier may be added to the dipping solution. In alternative embodiments, electrical device (1) coated by said tackifying solution can be dried in a 160° C. oven.

However, the skilled person can appreciate that any method known in the art for improving the adhesion of components to rubber may be used in this application such that the electrical device (1) remains intact and adhered to or within the tire through the lifetime of the tire.

In a preferred embodiment wherein said electrical device (1) is an RFID transponder, said antenna of said RFID tag includes at least one synthetic or biobased polymeric textile material. In a preferred embodiment of the invention, said textile material is a tacky material.

Said transfer layer (2) functions as a carrier for said electrical device (1). Said transfer layer (2) is made out of flexible material such as polyolefins, polyethylene terephthalate (PET), polyamides (PA), polyimides (PI), polyethylene naphthalate (PEN), flexible plastic films, cotton, paper, fiberglass or synthetic textiles. Said transfer layer (2) can be designed in a continuous or discontinuous form.

Said adhesive layer (3) covers the transfer layer (2) partially or completely and is used to attach the electrical device (1) to the transfer layer (2). Said adhesive layer (3) includes aqueous or solvent-based adhesive components. Said adhesive layer (3) is designed so that it is compatible with the tackifying pretreatment of the to the electrical device (1), but it is not compatible with the rubber component of the tire, so that when the electrical device pack (5) is applied to the tire, only the electrical device (1) is attached to the tire and the rest of the electrical device pack (5) can be removed. In a preferred embodiment of the invention, said adhesive layer (3) contains at least one material selected from the group consisting of silicone adhesives, rubber adhesives, acrylic adhesives, and combinations thereof.

Said tear-off cover (4) functions as a physical barrier for the electrical device (1), in order to protect said electrical device from outside factors such as heat, light and moisture. Said tear-off cover (4) is made out of flexible material such as plastic films, textiles, or paper. The tear-off cover (4) is removed manually or by automated systems prior to the application of the electrical device (1) to the tire.

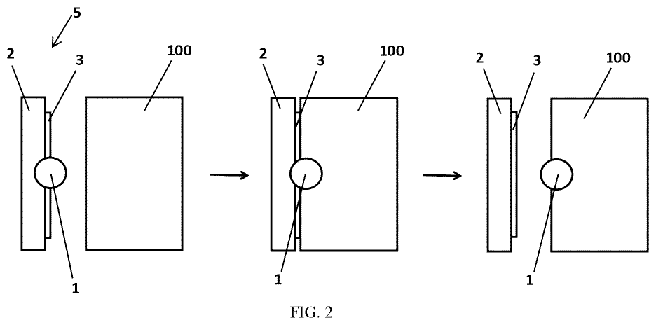

FIG. 2 demonstrates a method for mounting an electrical device (1) onto a tire. The electrical device (1) is mounted directly onto uncured rubber (100) of a tire before the curing process so that it is embedded among the layers including the final tire product. The tire types which can be equipped with the electrical device (1) include but are not limited to, bias tires, belted bias tires, radial tires, solid tires, semi-pneumatic tires, pneumatic tires, and airless tires. Generally, all tires include an outer tread, a bead which contacts a rim upon installation of the tire, and sidewalls that extend between the tread and bead. The method is advantageous in that it allows exact positioning of the electrical device (1) on the desired location and in a desired alignment on the tire without overhandling the electrical device (1) and causing damage.

It is most advantageous to place the electrical device (1) in positions that have minimum tensile and compressive strains during driving conditions. Preferably, the electrical device (1) is mounted between the carcass layer and the outer rubber layer at upper, middle, or lower sidewall area in the circumferential direction of tire. Good readability of the tag is obtained in these positions due to the thin gauge and the distance from the metallic components of the tire. In another embodiment of the invention, the electrical device (1) is mounted onto the bead area of the tire, including apex rubber and bead ring. The electrical device (1) may be mounted on the apex rubber or in the apex rubber in cases where the apex rubber is composed of two or more parts. These positions are advantageous due to reduced deformation in horizontal direction in driving conditions. In another embodiment of the invention, the electrical device (1) is mounted between the apex rubber and bead ring apex, wherein the electrical device (1) is mounted first on the upper side of the rubberized bead ring and the apex rubber is mounted onto the bead ring and the tag (1) This position is advantageous due to reduced deformation in all directions in driving conditions.

The method for mounting an electrical device (1) onto a tire includes the steps of:
Obtaining an electrical device pack (5),
Removing the tear-off cover (4) manually or by automated systems,
Applying electrical device pack (5), now including transfer layer (2), adhesive layer (3) and electrical device (1), onto the desired position on uncured rubber (100),
Holding electrical device pack (5) in this position on uncured rubber (100) to ensure adhesion,
Removing the transfer layer (2) and adhesive layer (3), leaving electrical device (1) mounted onto uncured rubber (100).

It is important to note that the tackiness strength of uncured rubber (100) is higher than the tackiness strength of said electrical device (1) and the tackiness strength of said electrical device (1) is higher than the tackiness strength of said adhesive layer (3), so that said electrical device (1) remains mounted onto said uncured rubber (100). In a preferred embodiment of the invention, uncured rubber (100) and electrical device (1) adhesion level is between 100-250 N, while electrical device (1) and adhesive layer (3) adhesion level is between 2-50 N.

From this point forward, other elements of the tire, such as tire cords, are be added onto the uncured rubber (100), and tire is cured in order to get the final tire product having an electrical device (1), such as an RFID transponder. Thereafter, the tire can be identified by the use of an RFID reader, which allows for tracking the tire in a manufacturing or production system, monitoring the location of the tire, and performing inventory operations.

The skilled person can appreciate that the electrical device pack (5) of the present invention can be used with other rubber or rubber-based articles in addition to tires. Other rubber-based articles include, but are not limited to, suspension components, cushions, shoe soles, hoses, hockey pucks, conveyor belts, musical mouth pieces and bowling balls.

In a nutshell, the present invention proposes an electronic device pack (5) including an adhesive layer (3) deposited onto a transfer layer (2), an electronic device (1) deposited onto said adhesive layer (3) and a tear-off cover (4) covering said electronic device (1).

In one variation of the present invention, said electronic device (1) includes at least one tacky material.

In a further variation of the present invention, said tacky material is a material that is treated at least once with a solution, and wherein said solution contains at least one material selected from the group consisting of resorcinol formaldehyde latex solution, acrylic resin solution, rosin ester solution, natural latex solution, and combinations thereof.

In a further variation of the present invention, said electronic device (1) is an RFID transponder.

In a further variation of the present invention, said RFID transponder includes an RFID chip and an antenna in operable communication.

In a further variation of the present invention, antenna of said RFID tag includes at least one synthetic or biobased polymeric textile material.

In a further variation of the present invention, said antenna of the RFID tag includes at least one tacky material.

In a further variation of the present invention, said transfer layer (2) includes at least one material selected from the group consisting of polyolefins, polyethylene terephthalate (PET), polyamides (PA), polyimides (PI), polyethylene naphthalate (PEN), flexible plastic films, cotton, paper, fiberglass, synthetic textiles, and combinations thereof.

In a further variation of the present invention, said adhesive layer (3) contains at least one material selected from the group consisting of silicone adhesives, rubber adhesives, acrylic adhesives, and combinations thereof.

In a further variation of the present invention, said transfer layer (2) is configured to protect said tag (1) from outside factors such as heat, light, and moisture.

The present invention also proposes a method for mounting an electrical device (1) onto a tire including the steps of:
a) obtaining an electrical device pack (5) as described in any one of claims 1 to 10,
b) removing the tear-off cover (4) manually or by automated systems,
c) applying electrical device pack (5), now including transfer layer (2), adhesive layer (3) and electrical device (1), onto the desired position on uncured rubber (100),
d) holding electrical device pack (5) in this position on uncured rubber (100) to ensure adhesion, and
e) removing the transfer layer (2) and adhesive layer (3), leaving electrical device (1) mounted onto uncured rubber (100).

In a variation of the present invention, the tackiness strength of uncured rubber (100) is higher than the tackiness strength of said electrical device (1) and the tackiness strength of said electrical device (1) is higher than the tackiness strength of said adhesive layer (3).

In a further variation of the present invention, the uncured rubber (100) and electrical device (1) adhesion level is between 100-250 N, while the electrical device (1) and adhesive layer (3) adhesion level is between 2-50 N.

What is claimed is:

1. An electronic device pack, comprising an adhesive layer deposited onto a transfer layer, an electronic device deposited onto the adhesive layer, and a tear-off cover covering the electronic device.

2. The electronic device pack according to claim 1, wherein the electronic device comprises a tacky material.

3. The electronic device pack according to claim 2, wherein the tacky material is treated at least once with a solution, wherein the solution contains at least one material selected from the group consisting of resorcinol formaldehyde latex solution, acrylic resin solution, rosin ester solution, natural latex solution, and combinations thereof.

4. The electronic device pack according to claim 1, wherein the electronic device is a radio-frequency identification (RFID) transponder.

5. The electronic device pack according to claim 4, wherein the RFID transponder comprises an RFID chip and an antenna in operable communication.

6. The electronic device pack according to claim 5, wherein the antenna of an RFID tag comprises at least one synthetic or biobased polymeric textile material.

7. The electronic device pack according to claim 5, wherein the antenna of an RFID tag comprises a tacky material.

8. The electronic device pack according to claim 1, wherein the transfer layer comprises at least one material selected from the group consisting of polyolefins, polyethylene terephthalate (PET), polyamides (PA), polyimides (PI), polyethylene naphthalate (PEN), flexible plastic films, cotton, paper, fiberglass, synthetic textiles, and combinations thereof.

9. The electronic device pack according to claim 1, wherein the adhesive layer contains at least one material selected from the group consisting of silicone adhesives, rubber adhesives, acrylic adhesives, and combinations thereof.

10. The electronic device pack according to claim 1, wherein the transfer layer is configured to protect a tag from outside factors comprising heat, light, and moisture.

11. A method for mounting an electrical device onto a tire, comprising steps of:
obtaining the electrical device pack according to claim 1,
removing the tear-off cover manually or by automated systems,
applying the electrical device pack, now comprising the transfer layer, the adhesive layer and the electrical device, onto a desired position on uncured rubber,
holding the electrical device pack in the desired position on the uncured rubber to ensure adhesion, and
removing the transfer layer and the adhesive layer, and leaving the electrical device mounted onto the uncured rubber.

12. The method according to claim 11, wherein a tackiness strength of the uncured rubber is higher than a tackiness strength of the electrical device, and the tackiness strength of the electrical device is higher than a tackiness strength of the adhesive layer.

13. The method according to claim 12, wherein an adhesion level of the uncured rubber and the electrical device is between 100 N-250 N, while an adhesion level of the electrical device and the adhesive layer is between 2 N-50 N.

14. The electronic device pack according to claim 2, wherein the electronic device is an RFID transponder.

15. The electronic device pack according to claim 3, wherein the electronic device is an RFID transponder.

16. The electronic device pack according to claim 6, wherein the antenna of an RFID tag comprises a tacky material.

17. The electronic device pack according to claim 2, wherein the transfer layer comprises at least one material selected from the group consisting of polyolefins, PET, PA, PI, PEN, flexible plastic films, cotton, paper, fiberglass, synthetic textiles, and combinations thereof.

18. The electronic device pack according to claim 3, wherein the transfer layer comprises at least one material selected from the group consisting of polyolefins, PET, PA, PI, PEN, flexible plastic films, cotton, paper, fiberglass, synthetic textiles, and combinations thereof.

19. The electronic device pack according to claim 4, wherein the transfer layer comprises at least one material selected from the group consisting of polyolefins, PET, PA, PI, PEN, flexible plastic films, cotton, paper, fiberglass, synthetic textiles, and combinations thereof.

20. The electronic device pack according to claim 5, wherein the transfer layer comprises at least one material selected from the group consisting of polyolefins, PET, PA, PI, PEN, flexible plastic films, cotton, paper, fiberglass, synthetic textiles, and combinations thereof.
